(19) United States
(12) Patent Application Publication
(10) Pub. No.: US 2007/0030288 A1
(43) Pub. Date: Feb. 8, 2007

(54) Apparatus and method for overlaying pattern data on a reproduced image

(75) Inventor: Naofumi Yamamoto, Kanagawa-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/194,596

(22) Filed: Aug. 2, 2005

(51) Int. Cl. G09G 5/00

(52) U.S. Cl. 345/629

(57) ABSTRACT

An apparatus and method for overlaying a pattern on an image includes loading pattern data stored in a program memory into an image memory and receiving image data and storing the received image data in the image memory. A processor overlays pattern data on to the received image data based on an overlay program. The processor has a first input channel and receives the pattern data and the received image data from the image memory via the first input channel.

### FIELD OF THE INVENTION

The present invention relates generally to image processing and, more particularly, to a system and method for overlaying pattern data on an image reproduced by an image forming apparatus.

### BACKGROUND OF THE INVENTION

To improve security and prevent the generation of counterfeit reproductions, some form of marking or information may be overlaid on the reproduction. Overlaying is the process of adding a pattern to an original image derived from a scan of a document, an image file, a data file, or other form of information that is capable of being reproduced. The overlaid pattern may be hidden or be a specific pattern, such as a yellow dot pattern, that specifically identifies the device that made the reproduction. The overlaying process may also be used for watermarking. The watermarking may be visible and showing, for example, identifying the copyright owner or that no copy should be made. For visible watermarking, the pattern data is formed on top of the original image data. Alternatively, the watermarking may be invisible. For invisible watermarking, the pattern data is added to the original image data electronically before forming the original image, such that the reproduced original image data shows no visible evidence of the pattern data.

To perform the overlaying process, the reproduced image is formed by doing a pixel by pixel calculation of the pattern data and the original image data, resulting in a large volume of data. For example, if the original image data is formed from a scan at 600 dpi, then the original image data would be approximately 36 megapixels in size for an A4-sized original. As a result of the large volume of data, the overlay process takes a long time. To compensate for this length time, the overlay process is typically performed by hardware, such as an application specific integrated circuit (ASIC) or high speed processor, which can perform image processing at a high speed. Although it is possible to reduce the time, such hardware typically has a very complex design, which makes the overlay hardware expensive.

It would therefore be desirable to have an overlay system that can perform an overlay process quickly and at a lower cost.

### SUMMARY OF THE INVENTION

According to an aspect of the invention, an image forming apparatus and method for overlaying a pattern on an image includes loading pattern data stored in a program memory into an image memory and receiving image data and storing the received image data in the image memory. A processor overlays pattern data on to the received image data based on an overlay program. The processor has a first input channel and receives the pattern data and the received image data from the image memory via the first input channel.

Further features, aspects and advantages of the present invention will become apparent from the detailed description of preferred embodiments that follows, when considered together with the accompanying figures of drawing.

### BRIEF DESCRIPTION OF THE DRAWINGS

FIG. 1 shows a block diagram of an overlaying system consistent with the present invention.

FIG. 2 shows a block diagram of the overlay processor of the overlaying system of FIG. 1

FIG. 3 is a representation of the program memory of the overlaying system of FIG. 1.

FIG. 4 is a flow diagram of an overlaying process consistent with the present invention.

### DETAILED DESCRIPTION OF PREFERRED EMBODIMENT

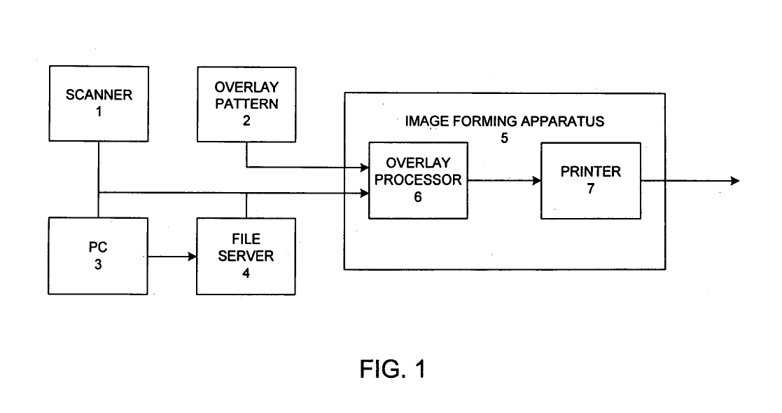

FIG. 1 shows a block diagram of an overlaying system consistent with the present invention. As shown in FIG. 1, the overlay system includes a scanner 1, an overlay pattern 2, a personal computer (PC) 3, a file server 4, and an image forming apparatus 5. The image forming apparatus 5 further includes an overlay processor 6 and a printer 7. The scanner 1, the overlay pattern 2, the PC 3, the file server 4, and the image forming apparatus 5 can be coupled to each other by a wired or wireless connection, and the connection can be a direct or a network connection, such as through a LAN or the Internet. The present invention is not limited in the type of connections that are used for communicating between the devices.

The scanner 1 is configured to generate image data representative of an original image on a document. To generate the image data, the scanner 1 preferably includes a document table for placement of a page of a document and an automatic document feeder (ADF) that provides pages to the document table. The ADF automatically feeds pages of the document one sheet at a time onto the upper surface of the document table.

The scanner 1 also includes a carriage that is reciprocally and movably provided on the lower side of the document table and an exposure lamp provided on the carriage. The carriage is reciprocally moved while the exposure lamp is being turned on. Thus, the entire surface of the document table is exposed and scanned.

The exposure scan obtains a reflection light image of the document page on the document table. The reflection light image is projected on a charge-coupled device (CCD) line sensor (CCD sensor) such as via reflection mirrors and a magnification-variable lens block. The CCD sensor outputs an image signal of a voltage level corresponding to a reception light amount. The image signal can be converted to digital image data by an analog-to-digital converter.

The overlay pattern 2 is the pattern used for an overlaying process. The design of the overlay pattern 2 may depend upon whether the pattern is to be visible or not, or whether the overlay process is for watermarking. For example, the overlay pattern 2 may be random data, a data pattern unique to a particular device, data intended to provide information about the reproduced image, or data that can be hidden when reproduced (or any other appropriate format for a pattern). The unique data pattern may be, for example, a bar code or serial number unique to the particular device performing the overlay processing so that it is possible to identify the device generating the image subjected to the overlay processing. The data providing information about the reproduced image may be, for example, a copyright date, the owner of the copyright, limitations on copying, etc. The overlay pattern 2 can be received from an external source and stored in the image forming apparatus 5, as discussed below. Alternatively, the overlay pattern 2 can be pre-stored in the image forming apparatus 5.

The PC 3 preferably includes a CPU, a main memory, a ROM, a storage device and a communication interface all coupled together via a bus. The CPU may be implemented as a single microprocessor or as multiple processors for a multi-processing system. The main memory is preferably implemented with a RAM and a smaller-sized cache. The ROM is a non-volatile storage, and may be implemented, for example, as an EPROM or NVRAM. The storage device can be a hard disk drive or any other type of non-volatile, writable storage.

The communication interface for the PC 3 provides a two-way data communication coupling, such as to a network. For example, if the communication interface is an integrated services digital network (ISDN) card or a modem, the communication interface provides a data communication connection to the corresponding type of telephone line. If the communication interface is a local area network (LAN) card, the communication interface provides a data communication connection to a compatible LAN. Wireless links are also possible. In any such implementation, the communication interface sends and receives electrical, electromagnetic or optical signals, which carry digital data streams representing different types of information.

If the network connection is an Internet connection, the PC 3 can transmit a requested code for an application program through the Internet, an ISP, the local network and the communication interface. The received code can be executed by the CPU in the PC 3 as it is received, stored in the storage device, or stored in some other non-volatile storage for later execution. In this manner, the PC 3 may obtain application code in the form of a carrier wave.

The file server 4 maintains documents or files that can be accessed by the other devices coupled to the file server 4. The file server 4 can include a processor, such as a CPU, a memory, which may include RAM, ROM and a hard disk drive, and a communication interface scheme to enable the file server 4 to communicate with other devices, such as over a network. The file server 4 can also include programming to enable it to perform file management functions.

The image forming apparatus 5 is a device which can perform the function of, for example, a printer, a fax machine, a copier, a plotter, a scanner or any other functional device that generates or processes images or text. The image forming apparatus 5 can also be implemented as a device, such as a multi-function peripheral (MFP), which is capable of performing the functions of two or more image processing devices, such as a combination of any of printing, faxing, copying, plotting and scanning. The scanner 1 can be implemented as part of image forming apparatus 5. Like the PC 3, the image forming apparatus 5 can include a CPU, a main memory, a ROM, a storage device and a communication interface all coupled together via a bus. The image forming apparatus 5 may also have a communication interface to provide a two-way data communication coupling, such as via a network link to a network. The communication interface enables the image forming apparatus 5 to receive data from and to output data to the scanner 1, the overlay pattern 2, the PC 3, and the file server 4. Instead of a network link, the image forming apparatus 5 may use a Universal Serial Bus (USB) or other direction communication link to connect to the other devices or elements of the overlaying system.

The overlay processor 6 of the image forming apparatus 5 preferably includes a CPU, one or more storage areas, such as a program memory and an image memory, and a communication interface all coupled together via a bus. The CPU may be implemented as a single microprocessor or as multiple processors for a multi-processing system. The overlay processor 6 is configured to perform overlay processing upon image data. The image data can be provided from the scanner 1, the PC 3, the file server 4, or another source, such as from the Internet. The pattern used for the overlay processing can be provided by the overlay pattern 2.

The printer 7 can generate a reproduction of a file provided by the scanner 1, the PC 3, or the file server 4. Further, the printer 7 can generate a reproduction of a file that has undergone overlay processing by the overlay processor 6. The printer 7 may be capable of producing monochrome or color reproductions. In addition, the printing type for the printer 7 can be, for example, laser, inkjet, bubble jet, or any other type of printing type.

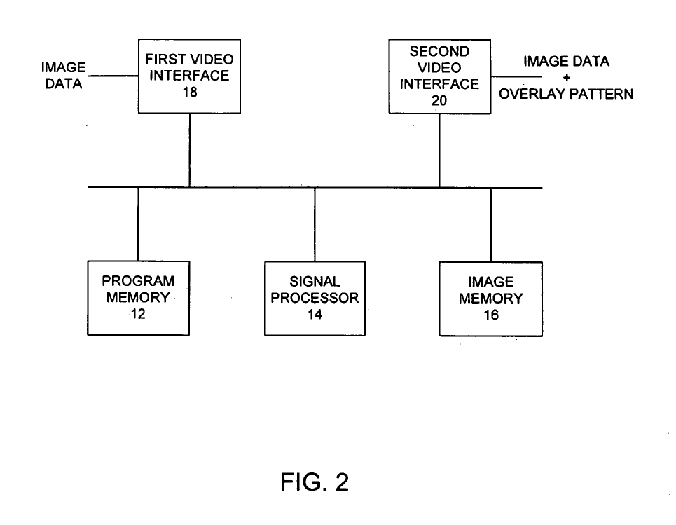

FIG. 2 shows a block diagram of the overlay processor of the overlaying system of FIG. 1. The overlay processor 6 of FIG. 1 can be implemented in accordance with the overlay processor of FIG. 2. As shown in FIG. 2, the overlay processor includes a program memory 12, a signal processor 14, an image memory 16, a first video interface 18, and a second video interface 20. The components communicate over a bus, which may be of any known form.

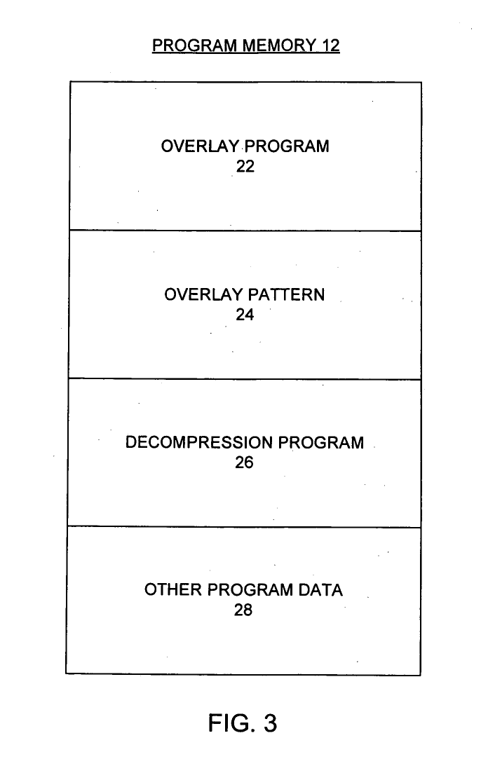

The program memory 12 is preferably a reprogrammable non-volatile memory, such as a non-volatile RAM, EPROM, or flash memory. The program memory 12 is configured to store data and programming used by the signal processor 14 to perform the overlay processing. FIG. 3 shows an exemplary representation of the program memory 12.

As shown in FIG. 3, the program memory 12 includes an overlay program 22, an overlay pattern 24, a decompression program 26, and other program data 28. The overlay program 22 comprises the programming, instructions, data, and other information used by the overlay processor to perform the overlay processing using the overlay pattern 24. For example, with reference to FIG. 2, the signal processor 14 operates according to the overlay program 22 to perform the overlay processing. The overlay program 22 can be configured to perform various types of overlay processing, such as watermarking, adding hidden patterns, or adding visible patterns. In addition, since the program memory 12 is preferably reprogrammable, the overlay program 22 can be reprogrammed or updated to add new overlaying functionality or to supplement existing functionality. The ability to reprogram or update the overlay program 22 provides greater flexibility to users desiring overlay processing.

The overlay pattern 24 may be implemented in the same manner as the overlay pattern 2, as described above with respect to FIG. 1. In particular, the overlay pattern 24 may be random data, a data pattern unique to a particular device, data intended to provide information about the reproduced image, or data that can be hidden when reproduced. In addition, if the program memory 12 is configured to be reprogrammable, then the overlay pattern 24 can be changed or updated to provide for a different overlay pattern used in the overlay processing. The overlay pattern 24 may also be stored in the program memory 12 in a compressed state. The overlay pattern 24 can be compressed using any type of known compression algorithm and particularly ones intended for the compression of image data. The compression of the overlay pattern 24 makes it possible to reduce the size of the program memory 12.

The decompression program 26 comprises the programming, instructions, data, and other information used by the overlay processor to decompress programs, data, or information stored in the program memory 12. For example, the decompression program 26 can be configured to decompress the overlay pattern 24 based on the compression algorithm used to compress the overlay pattern 24. The decompression program may include one or more decompression algorithms to accommodate varying algorithms used to compress the programs, data, or other information stored in the program memory 12. The other program data 28 can include, for example, a magnifying program and magnifying ratio data for a pattern. The overlay pattern can be magnified according to the magnifying program and magnifying ratio data and then overlaid onto the image.

The signal processor 14 is configured to perform the overlay processing. More specifically, the signal processor. 14 uses the overlay pattern 24 to perform overlay processing on an image in accordance with the overlay program 22. The signal processor 14 can be implemented as a processor, microprocessor, or CPU. More preferably, the signal processor 14 can be implemented as a high performance image processing (HPIP) CPU or ASIC, which is capable of processing image data and performing image processing quickly. If implemented as an HPIP CPU or ASIC, the signal processor 14 can be configured such that the overlay processing of the overlay program 22 is implemented in the signal processor 14 itself. In this case, it is not necessary to store the overlay program 22 in the program memory 12. The signal processor 14 is preferably configured to have an input channel that receives both the overlay pattern 24 and the image data being subjected to the overlay processing. In other words, the signal processor 14 preferably has a single channel to receive the overlay pattern 24 and the image data instead of two input channels respectively receiving the overlay pattern 24 and the image data (as is typical in conventional devices).

The image memory 16 is preferably configured as a reprogrammable storage medium that may or may not be non-volatile. Accordingly, the image memory 16 can be configured, for example, as a RAM, NVRAM, EEPROM, or flash memory. The image memory 16 is configured to receive and store image data received by the first video interface 18. The image memory 16 is also configured to provide the image data received from the first video interface to the signal processor 14 for overlay processing. The second video interface 20 is configured to receive the result of the overlay processing, i.e., the image data combined with the overlay pattern, from the signal processor 14. The second video interface 20 provides the result of the overlay processing to the printer 7, which generates a reproduction of the combined image data and overlay pattern.

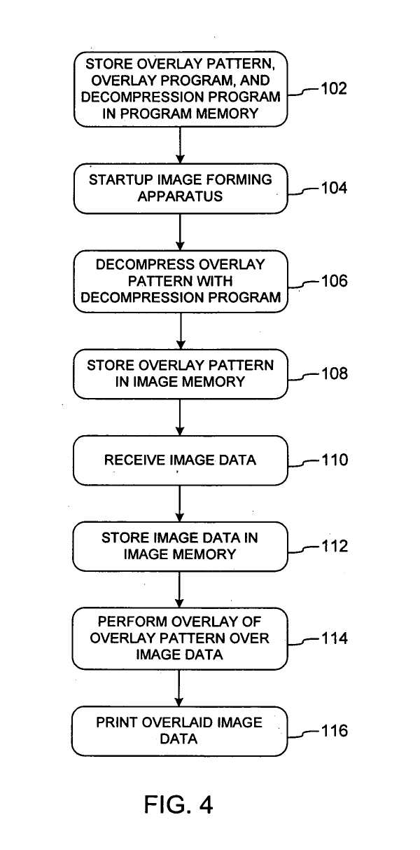

FIG. 4 is a flow diagram of an overlaying process consistent with the present invention. As shown in FIG. 4, the overlay process first stores an overlay pattern 24, an overlay program 22, and a decompression program 26 in the program memory 12 (step 102). The overlay pattern 24 may be one or more patterns. If there is more than one available pattern, then the overlay pattern 24 used in the overlay processing may be selected by a user, such as through an input through the image forming apparatus 5 or PC 3, as part of the request to perform overlay processing, or selected by default by the overlay processor 6. The storage of the overlay pattern 24, the overlay program 22, and the decompression program 26 in the program memory 12 can be performed during the manufacture of the image forming apparatus 5. Alternatively, the storage can be performed by a system administrator or technician after the manufacture and sale of the image forming apparatus 5, or during servicing of the equipment.

To initiate the overlay processing of input image data, the image forming apparatus 5 is started up (step 104). The image forming apparatus 5 is typically designed with an ON/OFF button or switch adjusted by a user to power on the image forming apparatus 5. The image forming apparatus 5 may also have a sleep status while powered on in which various systems and operations of the image forming apparatus are disabled to conserve power and resources, but which are enabled or reactivated in response to some form of input or selection by a user of any button or switch on the image forming apparatus 5. During the start up, which occurs in response to the powering on or activation from a sleep state, the image forming apparatus 5 activates various systems and functions used to perform the operations of the image forming apparatus. Among the systems and functions activated during startup can be the overlay processor 6.

In addition to starting up the image forming apparatus 5, the overlay pattern 24 stored in the program memory 12 is decompressed by the decompression program 26 (step 106). To perform the decompression, a system processor or the signal processor 14 can load the decompression program 26 into a working memory, such as a RAM, and operate in accordance with the loaded decompression program 26 to decompress the overlay pattern 24. The decompression of the overlay pattern 24 can be performed as part of the start up process for the image forming apparatus 5. Alternatively, the overlay pattern 24 may be decompressed in response to a request to the image forming apparatus 5 to perform an overlay process. The request may be received, for example, from the scanner 1, the PC 3, or the file server 4, or directly at the image forming apparatus 5 through an interface to a user. If there is more than one overlay pattern 24 stored in the program memory, then each of the overlay patterns 24 may be decompressed by the decompression program 26. Alternatively, a selected one of the overlay patterns 24 may be decompressed. The overlay pattern 24 that is decompressed may be selected as a default setting of the image forming apparatus 5, in response to the received request to perform a particular overlay process, or in random. In particular, the overlay process request can identify a type of overlay processing to be performed, and the overlay pattern 24 is chosen according to the identified type. Alternatively, the overlay process request may specifically identify which overlay pattern 24 to use. The decompressed overlay pattern 24 is stored in the image memory 16 (step 108).

The image forming apparatus 5 receives image data that is to be subjected to the overlay processing (step 110). The image data can be received from the scanner 1, the PC 3, or the file server 4. After scanning a document, the scanner 1 can provide the scanned image data to the image forming apparatus 5 in response to a user request to perform overlay processing on the scanned document. Similarly, a user at the PC 3 may request that a document or file present on the PC 3 or file server 4 be subjected to overlay processing before printing. The image data can also be received directly by the image forming apparatus 5. In particular, the image forming apparatus 5 may be used to copy a document or print a fax received at the image forming apparatus 5. The request to copy the document or print a fax received at the image forming apparatus 5 can include an indication or request to subject the reproduced document or fax to overlay processing. The image data received by the image forming apparatus 5, like the decompressed overlay pattern 24, is stored in the image memory 16 (step 112).

The signal processor 14 performs the overlay processing by overlaying the overlay pattern 24 upon the image data (step 114). More particularly, the signal processor 14 performs the overlay processing uses the overlay pattern 24 and the image data stored in the image memory 16 in accordance with the overlay program 22. In addition, the data for the overlay pattern 24 and the image data are preferably received by the signal processor 14 over a single input channel. The use of the single input channel to receive the overlay pattern 24 and the image data makes it possible to have a relatively simpler design for the signal processor 14, and thus lower the cost of the design and manufacture of the signal processor 14.

The data from the overlay pattern 24 and from the image data may be received serially or in parallel. Further, the signal processor 14 may alternately receive a bit from the overlay pattern 24 and a bit from the image data, or alternately receive a block of data from the overlay pattern 24 and a block of data from the image data. The size of the blocks of data are preferably configured, based on programming understood by the person of ordinary skill in the art, to enable the signal processor 14 to perform the signal processing in the fastest manner possible. As described above, the actual overlay processing may be, for example, a visible watermarking, an invisible watermarking, a hidden overlaid pattern, or a specific, visible overlaid pattern, such as to provide information about the image data or the image forming apparatus performing the overlay processing. The signal processor performs the overlay processing based on the overlay pattern 24 and the image data and outputs the result as the overlaid image data. The signal processor 14 provides the overlaid image to the printer 7 for printing via the second video interface 20 (step 116).

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method for overlaying a pattern on an image, comprising:
loading pattern data stored in a program memory into an image memory;
receiving image data and storing the received image data in the image memory; and
overlaying, by a processor, pattern data on to the received image data based on an overlay program,
wherein the processor has a first input channel and receives the pattern data and the received image data from the image memory via the first input channel.

2. A method according to claim 1, wherein the pattern data stored in the program memory is compressed,
wherein a decompression program is stored in the program memory, and
wherein the step of loading the pattern data includes decompressing the compressed pattern data with the decompression program.

3. A method according to claim 1, wherein the program memory stores a plurality of patterns of pattern data, the method further comprising:
receiving an indication of a type of overlay processing to perform on the received image data,
where the step of loading the pattern data includes selecting one of the plurality of patterns of pattern data to be overlaid on the received image data in accordance with the received indication.

4. A method according to claim 1, wherein the processor comprises an ASIC configured to perform the overlay program.

5. A method according to claim 1, wherein the overlay program is stored in the program memory, and
wherein the processor performs the overlaying of the pattern data on the received image data based on the overlay program stored in the program memory.

6. A method according to claim 1, wherein the overlay program is configured to provide a watermarking on the received image data based on the pattern data.

7. A method according to claim 1, wherein the processor outputs overlaid image data as a result of overlaying the pattern data on to the received image data, the method further comprising:
printing the overlaid image data.

8. A method according to claim 7, wherein the printed overlaid image data includes a visible indication of the pattern data.

9. A method according to claim 8, wherein the pattern data is formed on top of the received image data.

10. A method according to claim 7, wherein the printed overlaid image data includes no visible indication of the pattern data.

11. A method according to claim 10, wherein the processor adds the pattern data to the received image data electronically before printing the overlaid image data.

12. A method for overlaying a pattern on an image by an image forming apparatus, the image forming apparatus comprising an image memory, a program memory, and a processor, comprising:
storing an overlay program in the program memory, the overlay program being programmable;
loading programmable pattern data stored in the program memory into the image memory;
receiving image data; and
overlaying, by the processor, the programmable pattern data on to the received image data using the overlay program.

13. A method according to claim 12, wherein the pattern data stored in the program memory is compressed,
wherein a decompression program is stored in the program memory, and
wherein the step of loading the pattern data includes decompressing the compressed pattern data with the decompression program.

14. A method according to claim 12, wherein the program memory stores a plurality of patterns of pattern data, the method further comprising:
receiving an indication of a type of overlay processing to perform on the received image data,
where the step of loading the pattern data includes selecting one of the plurality of patterns of pattern data to be overlaid on the received image data in accordance with the received indication.

15. An image forming apparatus for overlaying a pattern on an image, comprising:
a program memory that stores pattern data to be overlaid on an image;
an image memory that stores the pattern data loaded from the program memory and that receives and stores image data upon which the pattern data is to be overlaid;
a processor having a first input channel that receives the pattern data and the received image data from the image memory and configured to overlay the pattern data on to the received image data based on an overlay program.

16. An image forming apparatus according to claim 15, wherein the pattern data stored in the program memory is compressed,
wherein the program memory further stores a decompression program that decompresses the compressed pattern data when the pattern data is loaded into the image memory.

17. An image forming apparatus according to claim 15, wherein the program memory stores a plurality of patterns of pattern data, and
wherein one of the plurality of patterns of pattern data to be overlaid on the received image data is selected according to a received indication of a type of overlay processing to perform on the received image data when the pattern data is loaded into the image memory.

18. An image forming apparatus according to claim 15, wherein the overlay program is stored in the program memory, and
wherein the processor performs the overlaying of the pattern data on the received image data based on the overlay program stored in the program memory.

19. An image forming apparatus according to claim 15, wherein the overlay program is configured to provide a watermarking on the received image data based on the pattern data.

20. An image forming apparatus according to claim 15, wherein the processor outputs overlaid image data as a result of overlaying the pattern data on to the received image data, the image forming apparatus further comprising a printer that prints the overlaid image data output from the processor.
